(19) United States
(12) Patent Application Publication
(10) Pub. No.: US 2018/0174117 A1
(43) Pub. Date: Jun. 21, 2018

(54) METHODS AND SYSTEMS FOR PROCESSING PAYMENT TRANSACTIONS

(71) Applicant: MasterCard International Incorporated, Purchase, NY (US)

(72) Inventors: Pravin Parekh, Pune (IN); Alex Staveley, Dublin (IE)

(21) Appl. No.: 15/797,511

(22) Filed: Oct. 30, 2017

(30) Foreign Application Priority Data
Dec. 19, 2016 (IN) 201641043316

(51) Int. Cl. G06Q 20/10; G06Q 30/06; G06Q 20/32; G06Q 20/40; H04L 9/32; G06F 17/30

(52) U.S. Cl. CPC G06Q 20/10; G06Q 30/06; G06Q 20/3223; G06F 17/30386; G06Q 20/4014; H04L 9/3228; G06Q 20/401

(57) ABSTRACT

A computer implemented method of processing a payment transaction is disclosed. The method comprises: receiving, in a payment processing server, an indication of an account associated with a payer; receiving, in the payment processing server, recipient identification information, the recipient identification information comprising an image of a recipient; determining, in a database search module of the payment processing server, an account associated with the recipient by searching a database using the recipient identification information; and initiating, in a transaction initiation module of the payment processing server, a payment transaction from the account associated with the payer to the account associated with the recipient.

### CROSS-REFERENCE TO RELATED APPLICATION

This application is a U.S. National Stage filing under 35 U.S.C. § 119, based on and claiming benefits of and priority to Indian Patent Application No. 201641043316 filed on Dec. 19, 2016. The entire disclosure of the above application is incorporated herein by reference.

### TECHNICAL FIELD AND BACKGROUND

The present disclosure relates to processing of digital payment transactions.

Although there has been growth in the use of digital payments in recent years there are still many scenarios in which payments are still generally made using cash transactions. These scenarios include payment for goods and services at small vendors such as fruit and vegetable stalls and newspaper and magazine outlets. Such vendors typically do not have infrastructure to process payment card transactions. Further in order to make a bank transfer, the recipient of the payment must provide the payer with their bank details. Similar scenarios also exist with person to person transactions.

In order to extend digital payments to the scenarios mentioned above, there is a need for a digital payment scheme that is simple to operate and understand and provides a level of trust or verification between a payer and a recipient of a digital payment transaction.

### SUMMARY

In general terms, the present disclosure proposes methods and systems for processing a digital payment transaction. In some embodiments the payer takes a photograph of the intended recipient and this photograph is used to determine account details for the recipient so that a payment can be initiated. Further, additional verification may be added using an identity card of the recipient and/or by provision of a one-time password (OTP).

According to a first aspect of the present invention, there is provided a computer implemented method of processing a payment transaction. The method comprises: receiving, in a payment processing server, an indication of an account associated with a payer; receiving, in the payment processing server, recipient identification information, the recipient identification information comprising an image of a recipient; determining, in a database search module of the payment processing server, an account associated with the recipient by searching a database using the recipient identification information; and initiating, in a transaction initiation module of the payment processing server, a payment transaction from the account associated with the payer to the account associated with the recipient.

In an embodiment the recipient identification information further comprises an indication of an identity document of the recipient. The indication of the identity document may be a unique identification number or unique identification code associated with the identity document. Alternatively, the indication of the identity document may be an image of the identity document.

In an embodiment determining an account associated with the recipient by searching a database using the recipient identification information comprises searching the database using the using the indication of the identity document to determine an identity of the recipient. In an embodiment the method further comprises verifying, in a verification module of the payment processing server, the identity of the recipient using the image of the recipient.

In an embodiment, determining an account associated with the recipient by searching a database using the recipient identification information comprises searching the database using the using the image of the recipient.

In an embodiment the method further comprises searching a second database using the identity of the recipient to determine the account associated with the recipient using the identity of the recipient.

In an embodiment the method further comprises: determining contact information for a communication device associated with the recipient; sending an indication of a one-time password to the device communication device associated with the recipient; receiving an indication of a one-time password response entered by the payer; and initiating the payment transaction from the account associated with the payer to the account associated with the recipient if the one-time password response matches the one-time password.

In an embodiment the method further comprises sending, by a transaction notification module of the payment processing server, a transaction completion indication to a communication device associated with the payer and/or a communication device associated with the recipient.

In an embodiment the method further comprises receiving an indication of a payment amount for the payment transaction.

According to a second aspect of the present invention, there is provided a system for processing a payment transaction. The system comprises: a computer processor and a data storage device, the data storage device having a database search module; and a transaction initiation module comprising non-transitory instructions operative by the processor to: receive an indication of an account associated with a payer; receive recipient identification information, the recipient identification information comprising an image of a recipient; determine an account associated with the recipient by searching a database using the recipient identification information; and initiate a payment transaction from the account associated with the payer to the account associated with the recipient.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram of a data processing system according to an embodiment of the present invention;

FIG. 2 is a block diagram illustrating a technical architecture of the apparatus according to an embodiment of the present invention;

FIG. 3 is a flowchart illustrating a method of initiating a transaction according to an embodiment of the present invention;

FIG. 4 is a flowchart illustrating a method of initiating a transaction according to an embodiment of the present invention; and

FIG. 5 is a flowchart illustrating a method of verifying an identity of a recipient according to an embodiment of the present invention.

### DETAILED DESCRIPTION

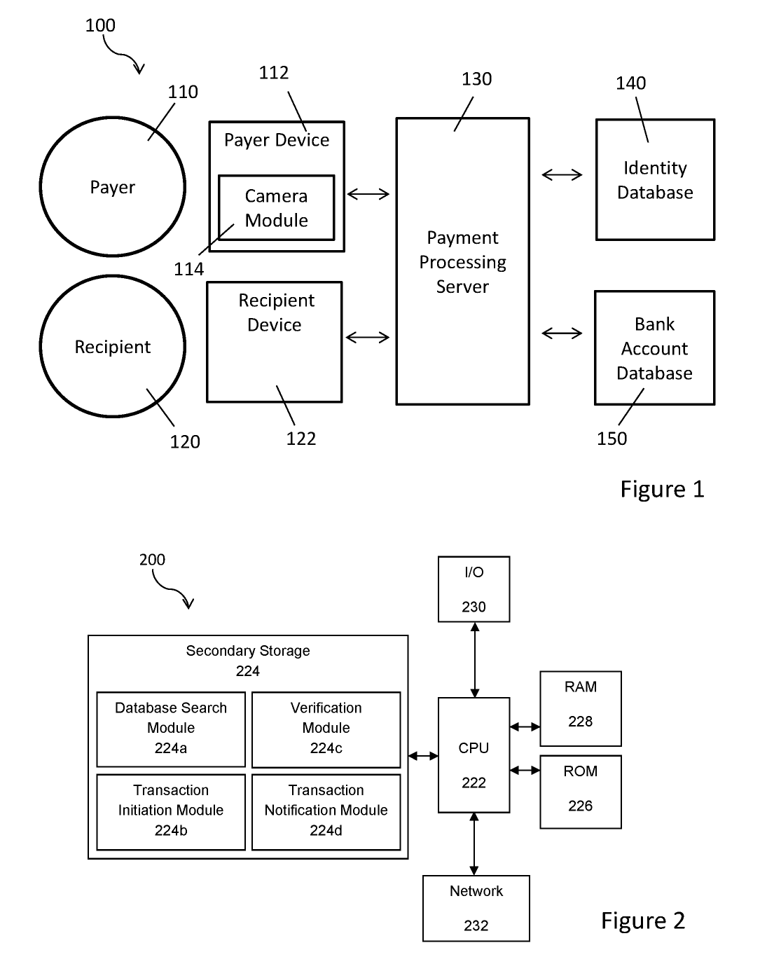

FIG. 1 is a block diagram showing a data processing system according to an embodiment of the present invention. The data processing system 100 processes payment transactions between a payer 110 and a recipient 120. A payer device 112 such as a smart phone or tablet device is associated with the payer 110. The payer device 112 comprises a camera module 114 which is operable to capture images. A recipient device 122 such as a smart phone or tablet device is associated with the recipient 120.

The data processing system 100 further comprises a payment processing server 130. The payment processing server 130 is connected to the payer device 112 and the recipient device 122 via a network such as the internet.

The payment processing server 130 is coupled to an identity database 140 and a bank account database 150. The identity database 140 stores images of individuals linked to indications of their identities. In one embodiment, the images correspond to merchants or other individuals who have registered to use a payment system as payment recipients. The individuals may be registered on behalf of an organisation. In an alternative embodiment, the identity database 140 is a national government database associated with an identity card system such as the AADHAAR system implemented by the Unique Identification Authority of India. The bank account database 150 stores indications of bank account numbers associated with individuals or merchants linked to indications of their identities. When an individual is registered on behalf of an organisation, a bank account number associated with the organisation would be linked the identity of that individual in the bank account database 150. It will be appreciated that the identity database 140 and the bank account database 150 may be located on separate physical storage media, or on different logical partitions of a single storage device. In some embodiments, they may be separate logical databases which span multiple storage devices.

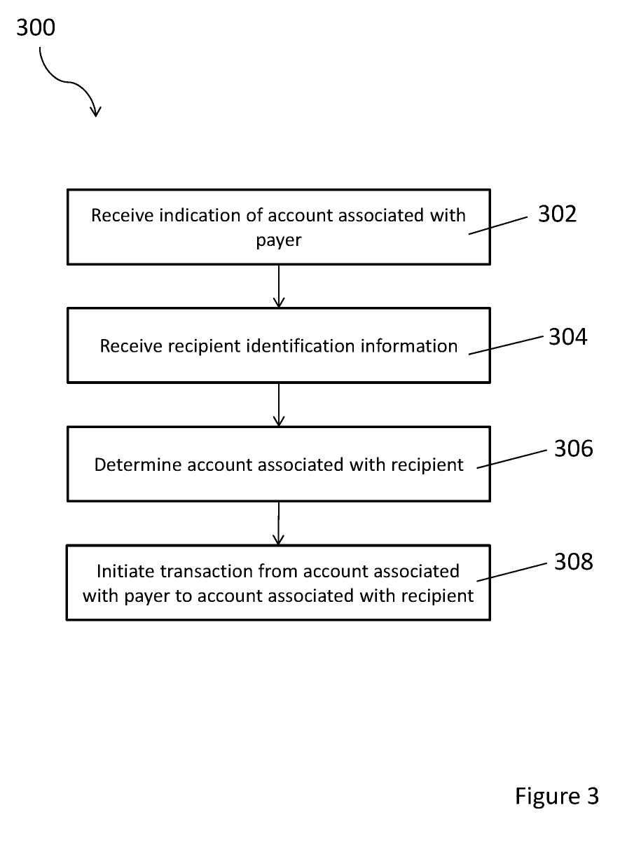

FIG. 2 is a block diagram showing a technical architecture 200 of the server of the payment processing server 130 for performing exemplary methods 300, 400 and 500 which are described below with reference to FIGS. 3, 4 and 5. Typically, the methods 300, 400 and 500 are implemented by a computer having a data-processing unit. The block diagram as shown FIG. 2 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a database search module 224a, a transaction initiation module 224b, a verification module 224c, and a transaction notification module 224d comprising non-transitory instructions operative by the processor 222 to perform various operations of the method of the present disclosure. As depicted in FIG. 2, the modules 224a-224d are distinct modules which perform respective functions implemented by the electronic commerce analysis server 200. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224d is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of an exemplary method 300 will now be described with reference to FIG. 3 in respect of initiating a transaction. It should be noted that enumeration of operations is for purposes of clarity and that the operations need not be performed in the order implied by the enumeration.

In step 302, the payment processing server 130 receives an indication of an account associated with the payer 110 from the payer device 112. The payer device 112 may run an application for initiating transactions which stores details of the account associated with the payer 110 and thus when the payer 110 wishes to initiate a payment transaction to the recipient the payer 110 may select the application which in turn sends an indication of the account associated with the payer 110 to the payment processing server.

In step 304, the payment processing server 130 receives recipient identification information from the payer device 112. The recipient identification information comprises an image of the recipient 120. Thus, as part of initiating the payment transaction the payer 110 uses the camera module 114 of the payer device 112 to capture an image of the recipient. This image is included in the recipient identification information sent by the application running on the payer device 112 to the payment processing server 130. In some embodiments, the application running on the payer device 112 sends a payment transaction request comprising both the indication of the account associated with the payer 110 and the image of the recipient 120. As such in some embodiments, steps 302 and 304 are performed together.

In step 302 or in step 304, the payer device may send an indication of a transaction amount for the payment transaction to the payment processing server 130. The transaction amount may be input by the payer 110 into the payer device 112.

In step 306, the database search module 224a of the payment processing server 130 determines an account associated with the recipient 120. Step 306 comprises the database search module 224a searching the identity database 140 using recipient identification information to determine the identity of the recipient and then using the identity of the recipient to search the bank account database 150 to determine the account associated with the recipient. In some embodiments, identity database 140 and the bank account database are combined and in such embodiments step 306 may comprise the database search module 224a searching the combined database using the recipient identification information to determine the account associated with the recipient.

In some embodiments, the recipient identification information comprises an image of the recipient 120. In such embodiments, the database search module 224a may use this image to conduct an image search of the identity database 140 to determine the identity of the recipient.

In the step 308, the transaction initiation module 224b of the payment processing server 130 initiates a transaction between the account associated with the payer and the account associated with the recipient for the transaction amount.

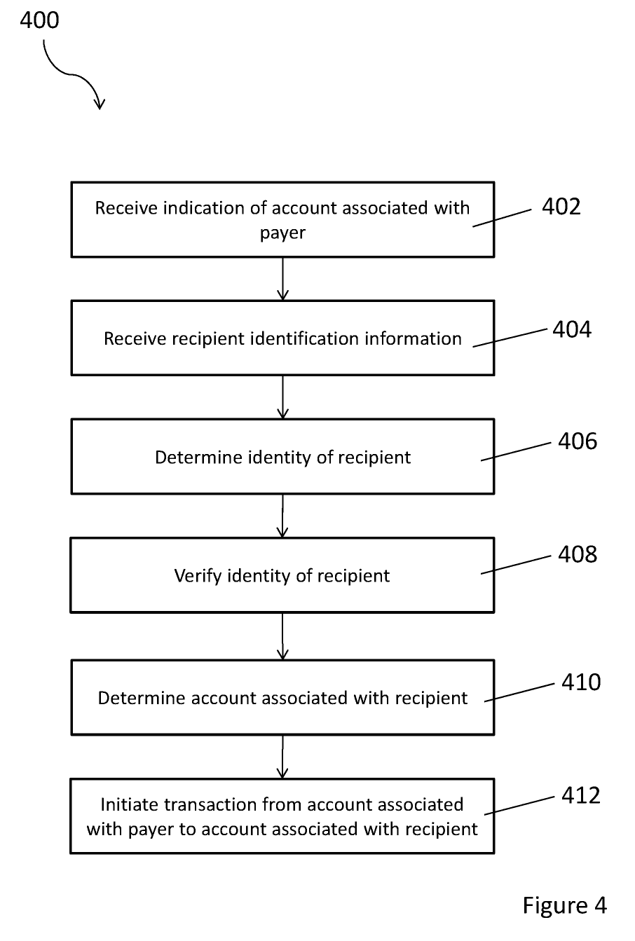

Various operations of an exemplary method 400 will now be described with reference to FIG. 4 in respect of initiating a transaction. It should be noted that enumeration of operations is for purposes of clarity and that the operations need not be performed in the order implied by the enumeration.

In step 402, the payment processing server 130 receives an indication of an account associated with the payer 110 from the payer device 112. The payer device 112 may run an application for initiating transactions which stores details of the account associated with the payer 110 and thus when the payer 110 wishes to initiate a payment transaction to the recipient the payer 110 may select the application which in turn sends an indication of the account associated with the payer 110 to the payment processing server.

In step 404, the payment processing server 130 receives recipient identification information from the payer device 112. The recipient identification information comprises an image of the recipient 120. Thus, as part of initiating the payment transaction the payer 110 uses the camera module 114 of the payer device 112 to capture an image of the recipient. This image is included in the recipient identification information sent by the application running on the payer device 112 to the payment processing server 130. In some embodiments, the application running on the payer device 112 sends a payment transaction request comprising both the indication of the account associated with the payer 110 and the image of the recipient 120. As such in some embodiments, steps 402 and 404 are performed together.

In some embodiments, the recipient identification information also comprises an indication of an identity document associated with the recipient. For example, the identity document may comprise a national identification card such as an AADHAAR card issued by the Unique Identification Authority of India. The indication of the identity document of the recipient may be an image of the identity document, for example, captured by the camera module 114 of the payer device 112. Alternatively, the indication of the identity document may be an indication of the identification number printed on the identity document.

In step 402 or in step 404, the payer device may send an indication of a transaction amount for the payment transaction to the payment processing server 130. The transaction amount may be input by the payer 110 into the payer device 112.

In step 406, the database search module 224a of the payment processing server 130 determines the identity of the recipient 120 using the recipient identification information. As described above, the recipient identification information may comprise an image of the recipient and/or an indication of an identity document of the recipient. Thus, in some embodiments, step 406 may comprise the database search module 224a using the indication of the identity document of the recipient to determine the identity of the recipient 120. Alternatively, or additionally, step 406 may comprise the database search module 224a using the image of the recipient 120 to determine the identity of the recipient.

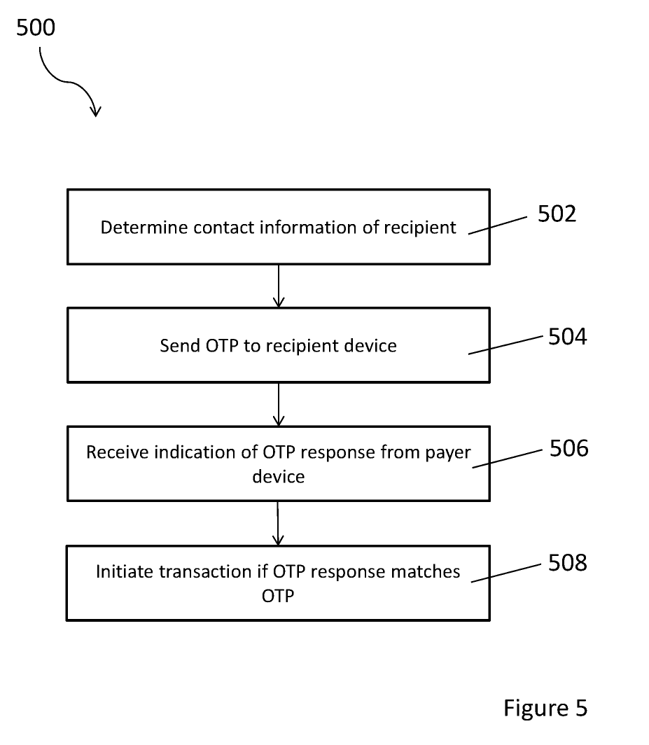

In step 408, the verification module 224c of the payment processing server 130 verifies the identity of the recipient 120. In one embodiment, the verification module 224c verifies the identity of the recipient by comparing the image received from the payer device 112 with an image of the recipient obtained from the identity database 140. In some embodiments, the verification module 224c sends a one-time password (OTP) to the recipient device 122. The recipient 120 then shares the OTP with the payer 110. The payer then enters the OTP into the payer device 112 which transmits the OTP to the payment processing server 130. This process is described below in more detail with reference to FIG. 5.

In step 410, the database search module 224a of the payment processing server 130 determines an account associated with the recipient 120 using the identity of the recipient 120. Step 410 may comprise the database search module 224a searching the bank account database 150 to determine a bank account associated with the recipient 120.

In step 412, the transaction initiation module 224b of the payment processing server 130 initiates a transaction between the account associated with the payer and the account associated with the recipient for the transaction amount.

In some embodiments, after either step 308 shown in FIG. 3 or after step 412 shown in FIG. 4, the transaction notification module 224d may send a notification of that the transaction has been initiated to the payer device 112 and/or the recipient device 122. The notification may take the form of a text message or email message.

Various operations of an exemplary method 500 will now be described with reference to FIG. 5 in respect of verifying the identity of a recipient. The method 500 shown in FIG. 5 may make up the step 408 shown in FIG. 4. In the embodiment described with reference to FIG. 5, the transaction authorization request relates to an online transaction. It should be noted that enumeration of operations is for purposes of clarity and that the operations need not be performed in the order implied by the enumeration.

In step 502, the verification module 224c of the payment processing server 130 determines contact information for the recipient. This contact information may be a mobile telephone number or an email address. The contact information may be determined from the identity database 140.

In step 504, the verification module 224c of the payment processing server 130 sends a one-time password (OTP) to the recipient device 122. The OTP may comprise a sequence of numbers or letters.

The OTP is then displayed to the recipient 120 by the recipient device 122. The recipient then communicates the OTP to the payer 110. The payer 110 then enters the OTP into the payer device 112 and the payer device 112 sends the OTP to the payment processing server 130 as an OTP response.

In step 506, the payment processing server 130 receives the indication of the OTP response from the payer device 112. The verification module 224c of the payment processing server 130 then compares the received OTP response with the OTP sent to the recipient device 112.

In step 508, if the OTP response matches the OTP, the transaction is initiated by the transaction initiation module 224b of the payment processing server.

Embodiments of the present invention may be applied to payments in various scenarios. In some of the examples described above, the embodiments apply to payments by a customer at a merchant. However, embodiments may also be applied to business to consumer payments, government to consumer payments and business to business payments.

Whilst the foregoing description has described exemplary embodiments, it will be understood by those skilled in the art that many variations of the embodiment can be made within the scope and spirit of the present invention.

1. A computer implemented method of processing a payment transaction, the method comprising:
receiving, in a payment processing server, an indication of an account associated with a payer;
receiving, in the payment processing server, recipient identification information, the recipient identification information comprising an image of a recipient;
determining, in a database search module of the payment processing server, an account associated with the recipient by searching a database using the recipient identification information; and
initiating, in a transaction initiation module of the payment processing server, a payment transaction from the account associated with the payer to the account associated with the recipient.

2. A method according to claim 1, wherein the recipient identification information further comprises an indication of an identity document of the recipient.

3. A method according to claim 2, wherein the indication of the identity document is a unique identification number or unique identification code associated with the identity document.

4. A method according to claim 2, wherein the indication of the identity document is an image of the identity document.

5. A method according to claim 2, wherein determining an account associated with the recipient by searching a database using the recipient identification information comprises searching the database using the using the indication of the identity document to determine an identity of the recipient.

6. A method according to claim 5, further comprising verifying, in a verification module of the payment processing server, the identity of the recipient using the image of the recipient.

7. A method according to claim 1, wherein determining an account associated with the recipient by searching a database using the recipient identification information comprises searching the database using the using the image of the recipient.

8. A method according to claim 5, further comprising searching a second database using the identity of the recipient to determine the account associated with the recipient using the identity of the recipient.

9. A method according to claim 1, further comprising:
determining contact information for a communication device associated with the recipient;
sending an indication of a one-time password to the device communication device associated with the recipient;
receiving an indication of a one-time password response entered by the payer; and
initiating the payment transaction from the account associated with the payer to the account associated with the recipient if the one-time password response matches the one-time password.

10. A method according to claim 1, further comprising sending, by a transaction notification module of the payment processing server, a transaction completion indication to a communication device associated with the payer and/or a communication device associated with the recipient.

11. A method according to claim 1, further comprising receiving an indication of a payment amount for the payment transaction.

12. A non-transitory computer-readable medium storing program instructions executed by a processor of a user device having a user interface, memory, and a network interface, the medium comprising instructions for causing the processor to perform a payment transaction, the method comprising:
receiving, in a payment processing server, an indication of an account associated with a payer;
receiving, in the payment processing server, recipient identification information, the recipient identification information comprising an image of a recipient;
determining, in a database search module of the payment processing server, an account associated with the recipient by searching a database using the recipient identification information; and
initiating, in a transaction initiation module of the payment processing server, a payment transaction from the account associated with the payer to the account associated with the recipient.

13. A system for processing a payment transaction, the system comprising:
a computer processor and a data storage device, the data storage device having a database search module; and a transaction initiation module comprising non-transitory instructions operative by the processor to:
receive an indication of an account associated with a payer;
receive recipient identification information, the recipient identification information comprising an image of a recipient;
determine an account associated with the recipient by searching a database using the recipient identification information; and
initiate a payment transaction from the account associated with the payer to the account associated with the recipient.

14. A system according to claim 13, wherein the recipient identification information further comprises an indication of an identity document of the recipient.

15. A system according to claim 14, wherein the indication of the identity document is a unique identification number or unique identification code associated with the identity document.

16. A system according to claim 14, wherein the indication of the identity document is an image of the identity document.

17. A system according to claim 14, wherein the database search module further comprises non-transitory instructions operative by the processor to: determine an account associated with the recipient by searching a database using the recipient identification information by searching the database using the using the indication of the identity document to determine an identity of the recipient.

18. A system according to claim 17, wherein the data storage device further comprises a verification module comprising non-transitory instructions operative by the processor to: verify the identity of the recipient using the image of the recipient.

19. A system according to claim 13, wherein the database search module further comprises non-transitory instructions operative by the processor to: determine an account associated with the recipient by searching a database using the recipient identification information by searching the database using the using the image of the recipient.

20. A system according to claim 17, wherein the database search module further comprises non-transitory instructions operative by the processor to: search a second database using the identity of the recipient to determine the account associated with the recipient using the identity of the recipient.

21. A system according to claim 13, wherein the data storage device further comprises a verification module comprising non-transitory instructions operative by the processor to:
determine contact information for a communication device associated with the recipient;
send an indication of a one-time password to the device communication device associated with the recipient;
receive an indication of a one-time password response entered by the payer; and
initiate the payment transaction from the account associated with the payer to the account associated with the recipient if the one-time password response matches the one-time password.

22. A system according to claim 13, wherein the data storage device further comprises a transaction notification module comprising non-transitory instructions operative by the processor to: send a transaction completion indication to a communication device associated with the payer and/or a communication device associated with the recipient.
